(19) United States
(12) Patent Application Publication
(10) Pub. No.: US 2003/0063431 A1
(43) Pub. Date: Apr. 3, 2003

(54) Network attached storage system with data storage device hot swap capability

(76) Inventor: Zbigniew S. Sobolewski, Longmont, CO (US)

Correspondence Address: CHRISTOPHER J. KULISH, ESQ, HOLLAND & HART LLP, P. O. BOX 8749, DENVER, CO, 80201-8749, US

(21) Appl. No.: 09/682,634

(22) Filed: Oct. 1, 2001

(51) Int. Cl. H02B 1/00; G06F 15/16

(52) U.S. Cl. 361/600

(57) ABSTRACT

The present invention is directed to a network attached storage system for storing data that provides the ability to “hot swap” a data storage device associated with the system while substantially reducing, during removal of the data storage device, the possibility that data being transferred between the data storage device and the exterior environment is lost or corrupted and/or damage to the data storage device.

### FIELD OF THE INVENTION

The present invention relates to a network attached storage system or device that facilitates the “hot swapping” of data storage devices,” i.e., facilitates the removal and/or insertion of a data storage device while power is being provided to the interface with which the data storage device mates.

### BACKGROUND OF THE INVENTION

Computer networks are comprised of computer systems and a communication infrastructure that permits the computers systems to communicate with one another. One advantage of a computer network is that one computer system can write/read data to/from a memory associated with another computer system in the network using the communication infrastructure. Typically, the transfer of data from one computer system in a network to another computer system in the network commences with the operating system of the computer system that wants to initiate the transfer of data (i.e., the initiating computer system) causing a request to read/write data to be conveyed over the network infrastructure to the computer system from/to which data is to be read/written (i.e., the target computer system). The operating system of the target computer system responds to the request by causing the appropriate commands to be issued to the memory device from/to which data is to be read/written. In the case of a “read” operation, the operating system causes the read data to be transferred over the network infrastructure to the initiating computer system. In the case of a “write” operation, the operating system typically causes a confirmation that the data has been written to the memory device to be conveyed over the network infrastructure to the initiating computer system. This system for transferring data between computer systems in a network has worked adequately for some time because the network infrastructure was considerably slower in transferring data between the computer systems than the operating system associated with the target computer system was able to process the request.

Recently, the bandwidth or speed of network infrastructures has increased dramatically. As a consequence, the network infrastructure is no longer the bottleneck in transferring data between computer systems in a network. Rather, the operating system associated with the target computer system is the bottleneck. To elaborate, the operating system of a typical, target computer system is responsible for servicing requests from application programs executing on the system, managing communications with the peripherals associated with the system, managing internal memory etc. As a consequence, the operating system can only devote a portion of its time to the processing of data transfers with other computer system in the network. Further, the time that can be devoted to such transfers is now, usually insufficient to fully utilize the bandwidth or speed at which the network infrastructure is capable of transporting data.

Due to the bottleneck presented by operating systems that are only capable of devoting a portion of their time to network data transfers, a new type of computer system or data storage system has evolved, namely, a network attached storage (NAS) device or system. A network attached storage device or system is a computer system that: (a) is accorded its own address within a network (b) contains or is capable of containing a memory device; and (c) is substantially dedicated to the storage and transfer of data. Consequently, the operating system associated with a network storage device is capable of devoting substantially all of its time to data transfers over the network.

Computer systems, regardless of whether they are general purpose systems or special purpose systems (like NAS systems), typically include one or more data storage devices. Common data storage devices include disk drives and tape drives. On occasion, one of these storage devices fails or must otherwise be replaced. The removal of a such a device from the computer system and insertion of a new device is commonly referred to as a “swap.” There are various types of swaps, each typically appropriate for a particular situation. A “cold” swap requires that the power being provided to the failed device be terminated and the data interface used to transfer data to and from the device to be placed in a secure condition before the device is removed. In many cases, the entire computer system is brought down before the device is replaced. Cold swapping is generally practiced on stand alone computer systems because the time spent in bringing the system down, swapping the device, and then bringing the system back to an operational state is generally not a concern. There are, however, situations in which the time needed to perform a cold swap is a concern. In such situations it is desirable to perform a “hot” swap, i.e., removal of the device while power is still being provided to the device and the subsequent insertion of a new device. Hot swaps generally find applicability in computer networks where there is a commonly a premium on maintaining the entire computer network in an operational condition. Presently, known “hot” swapping systems detect the removal of a data storage device as the electrical connections are being broken or after the connections are broken. Consequently, data being transferred to or from the device during the swap is subject to loss or corruption.

### SUMMARY OF THE INVENTION

The present invention is directed to a network attached storage device or system that is capable of accommodating at least one data storage device and “hot” swapping of the device in a manner that prevents the loss or corruption of any data. The device or system prevents the loss or corruption by anticipating the removal of the data storage device and terminating any data transfers before the electrical connections are broken.

In one embodiment, a network attached storage device or system is provided that comprises an enclosure that is capable of accommodating at least one data storage device, a first electrical interface for providing power and a data connection to a data storage device, and a mounting bay. Comprising the mounting bay are a carriage capable of holding a data storage device and including a second interface that is capable of engaging the first interface, a receiving structure capable of holding the carriage, and a latch that allows the carriage to be operatively attached/detached to/from the enclosure. Further included in the device or system is a detector that is capable of sensing the movement of a physical structure that is indicative of the possible disengagement of the second electrical interface associated with the carriage from the first electrical interface and producing a signal that is indicative of the movement. Processing electronics are provided for receiving the signal indicative of the possible separation of the electrical interfaces and causing action to be taken to prevent the loss or corruption of data being transferred to or from any device associated with the carriage.

In another embodiment, a latch comprised of a latch actuator and a latch pin is constructed such that, to allow the carriage to be detached from the enclosure, the latch actuator must be moved a certain distance before the interaction of the latch actuator and the latch pin begin to cause the first and second electrical interfaces to disengage. The detector senses the movement of the latch actuator that occurs before the latch actuator and latch pin have caused the first and second electrical interfaces to disengage to the point at which there would be a loss or corruption of any data being transferred over the interfaces. In response to the sensed movement, the detector produces a signal that is provided to the processing electronics.

In a further embodiment, the network attached storage system provides for a certain amount of movement of the carriage before the first and second electrical interfaces begin to disengage. A detector senses relative movement between the carriage and an element within or part of the enclosure during the time before the first and second electrical interfaces become disengaged such that there would be loss of corruption of any data being conveyed over the interfaces. In response to the sensed relative movement, the detector generates a signal that is provided to the processing electronics.

Yet another embodiment includes processing electronics for executing an operating system that responds to the signal generated by the detector or the equivalent thereof by causing the electrical lines for transporting data and that are associated with the first electrical interface to be grounded. In another embodiment, the processing electronics that are responsive the signal generated by the detector are separate from the operating system and capable of securing the data portion of the first electrical interface without the aid of the operating system.

### BRIEF DESCRIPTION OF THE DRAWINGS

FIGS. 1A and 1B illustrate an embodiment of a network attached storage system according to the present invention;

FIG. 2 illustrates the general layout of the interior of the enclosure of the system shown in FIG. 1;

FIG. 3 illustrates the receiving structure portion of a mounting bay;

FIG. 4 illustrates the carriage portion of a mounting bay;

FIG. 5A is a cross-sectional view that illustrates the relationship of the rail and carriage structures to a data storage device;

FIG. 5B is a cross-sectional view of the 1U enclosure of FIG. 1 with four data storage devices that are each attached to a carriage as shown in FIG. 4 that is engaged to a receiving structure of the type shown in FIG. 3;

FIG. 6 illustrates one embodiment of a latch mechanism that is suited for attaching the carriage to enclosure;

FIGS. 7 and 8 illustrate the electrical interface between a data storage device and a buss card terminal;

FIG. 9 is a block diagram of the major hardware components within the embodiment of the system illustrated in FIG. 1;

FIG. 10 is a block diagram of the electrical components associated with a storage unit as identified in FIG. 9;

FIG. 11 is a block diagram of the electrical components the condition monitoring and Power/Data Buss Control System shown in FIG. 9;

FIG. 12 is a flow diagram of the logic associated with a hot swap operation.

### DETAILED DESCRIPTION

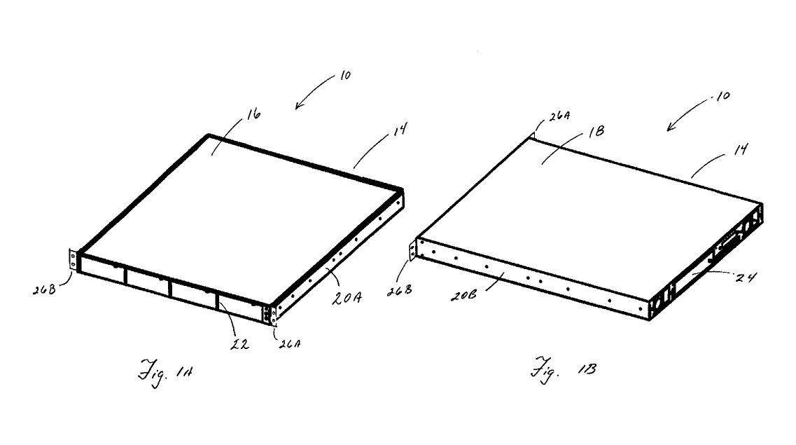

FIGS. 1A and 1B illustrate an embodiment of a network attached storage system 10, which is hereinafter referred to as system 10. The system 10 includes an enclosure 14 for housing the other elements of the system 10. The enclosure includes a top wall 16, a bottom wall 18 that is substantially parallel to the top wall 16, a first side wall 20A, a second side wall 20B that is substantially parallel to the first side wall 20A, an open front wall 22 that defines four openings through which data storage devices can be inserted into and removed from the enclosure 14; and a rear wall 24 that provides a mounting structure for various electrical and mechanical interfaces. The rear wall 24 provides a mounting structure for interfaces for: (1) conveying data between the system 10 and a computer network; (2) providing power to the system 10; and (3) venting heat produced by the system 10.

The enclosure 14 is also suitable for mounting in a computer rack that is capable of storing the system 10 and other systems or computer devices in a vertical stack. In this regard, the illustrated enclosure 14 conforms to the EIA-310-D standard, which specifies the dimensions of systems or devices that are mounted in a rack with a specified width. Specifically, the enclosure 14 has a width of approximately 17.7 in/450 mm (not including any mounting flanges). The height of the enclosure 14 is 1.75 in./44.45 mm, which characterizes the enclosure as a 1U enclosure. The depth of the enclosure 14 is approximately 20 in./508 mm. To facilitate the mounting of the system 10 to a rack, a pair of flanges 26A, 26B are provided that each include a pair of holes that accommodate bolts that are used to mount the system 10 to a rack.

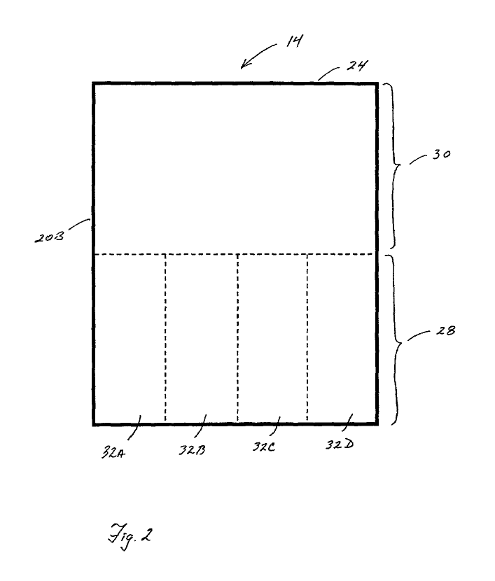

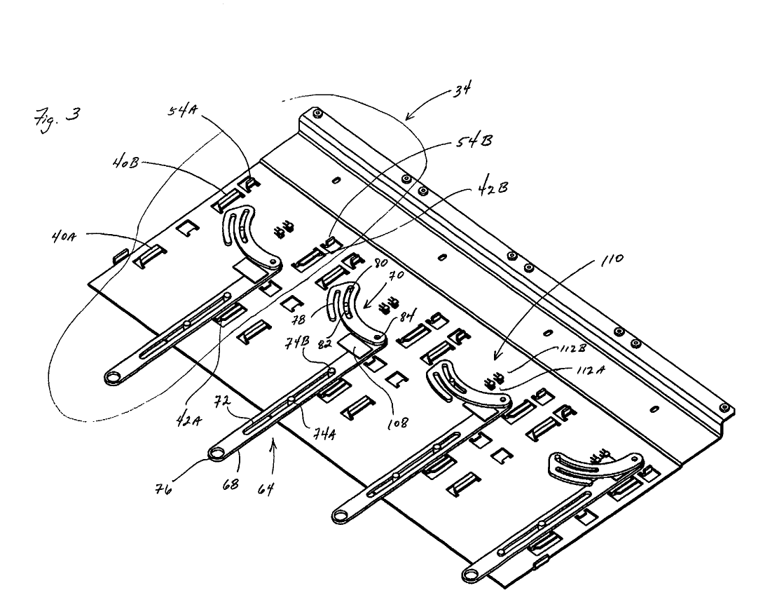

With reference to FIG. 2, the layout of the various components contained within the enclosure 14 is described. The enclosure 14 includes a mounting bay 28 for accommodating one or more data storage devices and an electronics bay 30 for housing power supplies, cooling fans, processing and memory circuitry etc. Typically, a memory device within the electronics bay is capable of being programmed with the desired network address of the system 10. In the illustrated embodiment, the mounting bay 28 is divided into four, subsidiary mounting bays 32A-32D, each capable of accommodating a 3½″ disk drive.

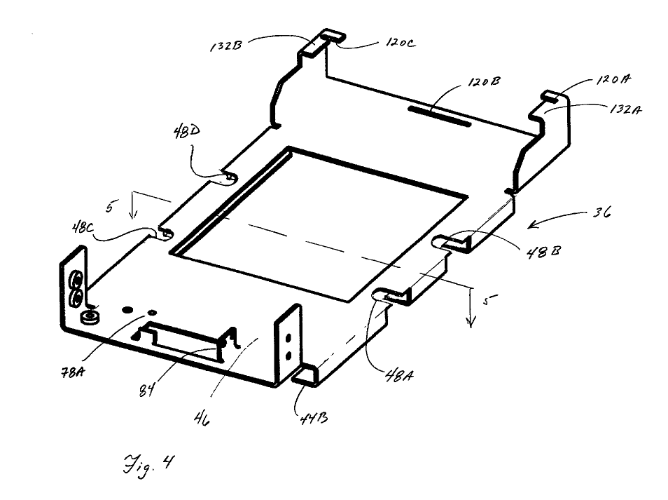

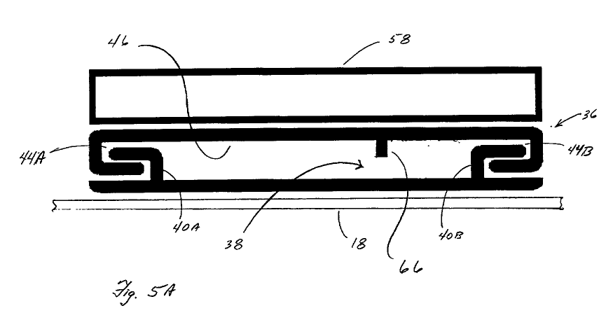

With reference to FIGS. 3-6, the structure of the mounting bay 28 is described in greater detail. Generally, the mounting bay 28 provides the ability to mount as many data storage devices as possible in a row extending across an enclosure of a given width by providing a mounting structure that avoids establishing any portion of the mounting structure in the spaces between the data storage devices or between the data storage devices and the side walls 20A, 20B of the enclosure 14. In the illustrated embodiment, the mounting bay 28 includes the four, subsidiary mounting bays 32A-32D that are substantially identical to one another. As a consequence, only one of the four, subsidiary mounting bays 32A-32D is described in detail. Generally, the mounting bay 32A includes a receiving structure 34 that is attached to or part of the enclosure 14 and a carriage 36 for holding a data storage device and engaging the receiving structure 34. The carriage 36 can also be disengaged from the receiving structure 34 to remove, for example, a data storage device that is attached to the carriage 36 from the system 10. The receiving structure 34 and the carriage 36, when engaged with one another, have a width that is substantially equal to the width of the data storage device for which the carriage 36 is designed. As a consequence, implementation of the mounting bays 32A-32D require the use of little, if any, of the lateral space available in the enclosure 14 that would not also be used by a data storage device. This, in turn, allows the number of data storage devices that can be established across the width of the enclosure to be maximized, whether the width of the devices is the same from device to device or different.

In the illustrated embodiment, the receiving structure 34 includes a rail structure that is formed of opposing L-shaped legs, one leg realized by a first pair of L-shaped tabs 40A, 40B and the second leg realized by a second pair of L-shaped tabs 42A, 42B. The carriage 36 includes a pair of opposed U-shaped channels 44A, 44B that allow the carriage 36 to be slid on and off of the rail structure to mount and dismount the carriage 36 via an opening in the open front wall 22. Extending between the U-shaped channels is a floor 46 for supporting a data storage device. Four notches 48A-48D are disposed in the U-shaped channels 44A, 44B for accommodating screws that engage holes disposed in the mounting surface of a data storage device and facilitating access to any such screws or other fastening devices. A pair of blocks 54A, 54B are provided in the receiving structure 34 to cooperate with a pair of cutouts associated with the U-shaped channels 44A, 44B to facilitate lateral alignment of the carriage 36 within the enclosure 14 during insertion of the carriage 36 so that an electrical connector associated with the carriage 36 can mate with an electrical connector associated with a buss card.

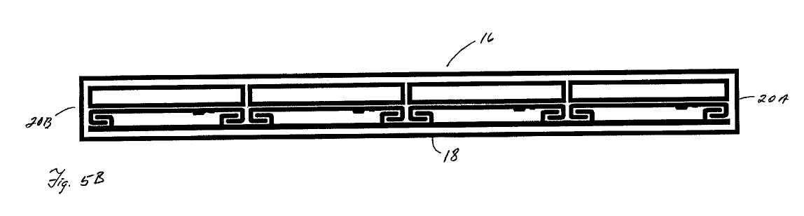

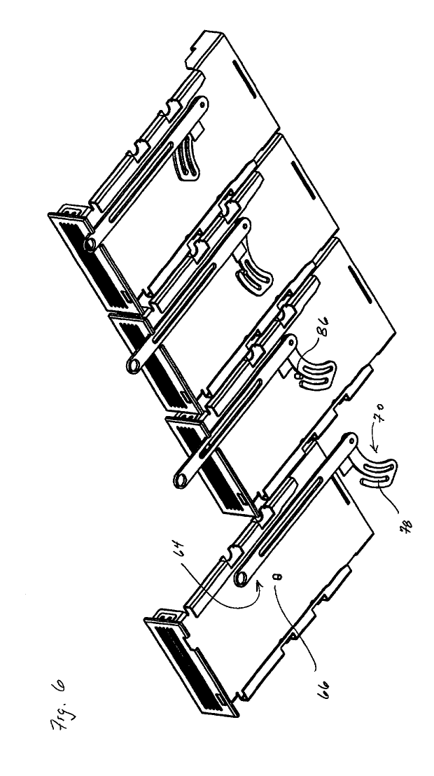

FIG. 5A is a cross-sectional view of a data storage device 58 mounted on the carriage 36 and the carriage 36 engaged with the rail structure. As can be seen, the carriage 36 and rail 38 are substantially entirely located between the data storage device 58 and the bottom wall 18 of the enclosure. Stated differently, the carriage 36 and rail 38 do not extend substantially beyond the width of the data storage device 58. As a consequence, the carriage 36 and rail 38 allow the data storage devices to be positioned very close to one another and thereby maximize the number of data storage devices that can be established across the width of the enclosure 14. In this regard, FIG. 5B is a cross-sectional view of the 1U enclosure shown in FIG. 1 with four data storage devices attached to four carriages that are, in turn, engaged to four rail structures that are established across the width of the 1U enclosure. The data storage devices, in the illustrated embodiment, are 3½″ IDE disk drives.

It should be appreciated that while the receiving structure 34 is shown as incorporating a rail structure and the carriage as incorporating a slot structure, a number of variations are possible that facilitate close positioning of the data storage devices. For instance, the close positioning of data storage devices can also be realized with a slot structure that is associated with the receiving structure and a rail structure that is associated with the carriage. Changes in the shapes, locations, orientations and/or materials used to realize the rail and slot structures are also feasible. For instance, (1) the rail structure can be realized with a T-shaped structure, as opposed to two L-shaped structures; (2) the illustrated L-shaped legs used to realize the rail structure can be re-oriented to face inward rather than outward; (3) the illustrated L-shaped legs used to realize the rail structure can be replaced with separate components that are attached to the enclosure rather than stamped from a piece of metal; (4) the L-shaped legs can also be realized in the enclosure itself rather than using a separate piece of metal. Many other variations are also feasible.

With reference to FIGS. 3, 4, 5A and 6, a latch mechanism for attaching the carriage 36 to the enclosure 14 is described. Generally, the latch mechanism includes a latch actuator or lever 64 and a latch pin 66 that is engaged by the latch actuator 64 when the carriage 36 is being attached to the enclosure. In the illustrated embodiment, the latch actuator 64 includes a handle 68 and a slot defining structure 70 for engaging the latch pin 66. The handle 68 includes a first slot 72 that is engaged by a pair of flanged posts 74A, 74B that are attached to the receiving structure 34. The first slot 72 and flanged posts 74A, 74B cooperate so as to limit the handle to linear movement. A finger hole 76 facilitates grasping of the handle 70. The slot defining structure 70 comprises a second slot 78 for use in engaging the latch pin 66. A third slot 80 is engaged by a flanged post 82 that is operatively attached to the receiving structure 34. A pin 84 attaches the handle 68 to the slot defining structure 70. Since, the handle 68 is constrained to move linearly, the pin 84 is also constrained to linear movement. The linear movement of the pin 84 and the flanged post 84 within the third slot 80 cooperate to constrain the movement of the slot defining structure 70.

With reference to FIGS. 3 and 6, the attachment/detachment of the carriage 36 to/from the enclosure 14 is described. FIG. 6 is a series of free body diagrams that illustrate the interaction of the latch actuator 64 and the latch pin 66 when the carriage 36 is attached to or detached from the enclosure 14. To insert the carriage 36 into the enclosure 14, the handle 68 is pulled away from the enclosure until the flanged post 74B prevents further withdrawal. With the handle 68 in this position, the slot defining structure 70 is positioned so that the second slot 78 can engage the latch pin 66. In addition, the carriage 36 is positioned so that the opposed U-shaped channels 44A, 44B engage the rail 38. The carriage 36 is then inserted until there is contact between a curved surface 86 associated with the slot defining structure 70 and the latch pin 66. At this point, the handle 68 is pushed inwards so that the second slot 78 engages the latch pin 66. The inward pushing of the handle 68 continues until further movement is prevented by the flanged post 74A. When a user desires to remove the carriage 36 from the enclosure 14, the user pulls the handle 68 away from the enclosure 14. The movement of the handle 68 causes the curved surface 86 to push against the latch pin 66 such that the carriage 36 is pushed out of the enclosure 14. Once the latch pin 66 is clear of the second slot 78, the carriage 36 can be removed.

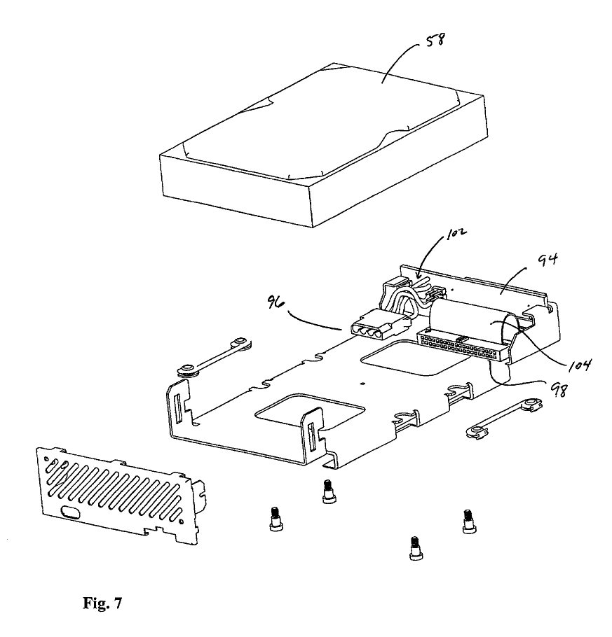

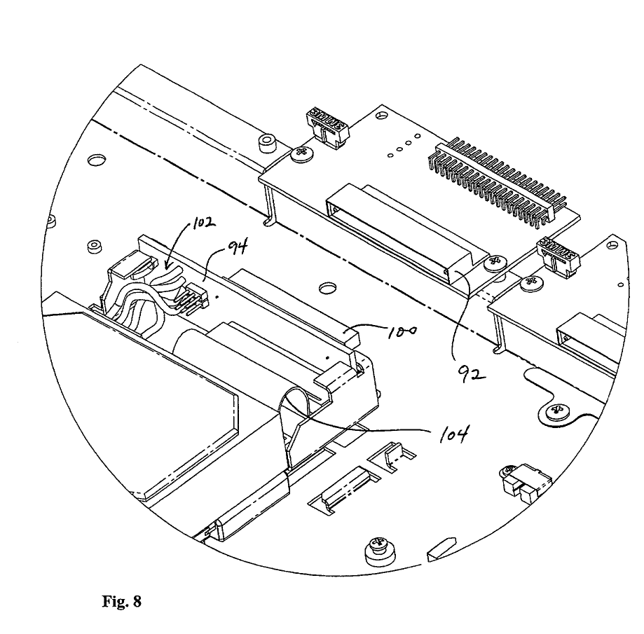

With reference to FIGS. 7 and 8, the electrical interface located between a 3½″ IDE disk drive 90 and a buss card terminal 92 associated with the electronics bay 30 and through which data is transferred to and from the drive 90 and power is transferred to the drive 90 is described. Generally, the electrical interface includes a card 94 that is associated with the carriage 36. Located on one side of the card 94 are a power terminal 96 for interfacing with the power interface associated with the drive 90 and a data terminal 98 for interfacing with the data interface associated with the drive 90. Located on the other side of the card 94 is a card terminal 100 that is adapted to interface with the buss card terminal 92. A group of flexible power conductors 102 extends between the card 94 and the power terminal 96. The conductors 102 allow the power terminal 96 to be positioned to accommodate variations in the location of the power interface associated with the drive 90. Additionally, the conductors 102 provide vibration dampening. A flat cable conductor 104 extends between the card 94 and the data terminal 98. In one embodiment, the flat cable conductor 104 has been split into a plurality of strands to facilitate positioning of the data terminal 98 to accommodate variations in the location of the data interface associated wit the drive 90. The flexible cable conductor 104 also provides vibration dampening. The card 94 includes printed circuits that establish the electrical connections between: (a) the conductors 102 and the card terminal 100; and (b) the flat cable conductor 104 and the card terminal 100.

Insertion of the carriage 36 into the enclosure 14 ultimately results in the card terminal 100 engaging the buss card terminal 92 such that power and data can be transmitted to a data storage device, such as drive 90, that is operatively attached to the carriage. Removal of the carriage 36 from the enclosure 14, as described with respect to the operation of the latch mechanism, ultimately results in the electrical connections between the card terminal 100 and the buss card terminal 92 being severed. If the data storage device 90 attached to the carriage 36 is an IDE disk drive, the removal of the carriage 36 and associated drive can damage the drive and possibly result in the loss or corruption of any data being transmitted across the interface at the time of removal, especially data being written to the drive.

The present invention addresses the problem of the removal of a data storage device, and particularly IDE disk drives, from a network attached storage system while power is being provided to the device. Generally, the invention comprises the sensing of the movement of physical structure that is indicative of the possible removal of the data storage device, producing a signal representative of the sensed movement, and the processing of the signal such that action is taken before the electrical interfaces are at a point of disengagement at which there would be a loss or corruption of data being transferred and/or damage to the data storage device. While the invention is described in the context of the network attached storage system 10 as described hereinabove, it should be appreciated that the invention is not limited to network attached storage systems that accommodate IDE disk drives. The invention is equally applicable to other kinds of disk drives, as well as tape drives. Furthermore, while the movement associated with the latch actuator 64 is sensed, it should also be appreciated that the invention is also adaptable to sensing movement associated with other types and designs of latches. Additionally, the invention is capable of being adapted to sense relative movement not directly related to the operation of a latch mechanism. For instance, the relative movement between a carriage and another structure within the enclosure can also be sensed. It should be further appreciated that the invention is not limited to detecting the potential disengagement of the electrical interface described hereinabove but is applicable to electrical interfaces with different structures, including interfaces in which the data storage device is directly connected to a buss card terminal or similar structure. Additionally, the invention is capable of being used with mounting bays that utilize different structures. For instance, the invention is adaptable to mounting bays in which the carriage is the shell or exterior covering of the data storage device. Further, the invention is adaptable to any kind of network attached storage system with one or more data storage devices, provided there is some movement that is capable of being sensed sufficiently prior to the point in time at which the electrical interface or interfaces associated with the data storage device reach a point of disconnection at which there would be a loss or corruption of data being transferred over the interface and/or damage to the storage device.

With reference to FIG. 3, an embodiment of a sensor for sensing movement associated with latch actuator 64 and providing a signal indicative thereof is described. The sensor comprises a flag 108 and an electro-optical detector 110 for sensing movement of the flag 108 and, in particular, movement indicative of the possible removal of the carriage 36 and any associated data storage device. The flag 108 and electro-optical detector 110 are located such that movement of the handle 68 which is indicative of the possible removal of the carriage 36 and any associated data storage device is detected before the buss card terminal 92 and card terminal 100 reach a point at which any data being transferred over the interface would be lost or corrupted or the data storage device damaged. Stated differently, the latch mechanism is designed such that the handle 68 must move through an “idle distance” before the buss card terminal 92 and card terminal 100 reach a point at which data corruption or damage to the storage device would occur. The sensor detects the movement of the handle 68 during movement through the “idle distance.” The electro-optical detector 110 includes first and second detectors 112A, 112B that each output a signal whose state changes from a first level to a second level depending upon whether or not the flag 108 is positioned in front of the detector or not. These signals are processed to identify when the signal being produced by the second detector 112B transitions from a first state to a second state followed by the signal being produced by the first detector 112A transitioning from a first state to a second state, which is indicate of the handle 68 being withdrawn to remove the carriage 36 and any associated data storage device. When this sequence of state transitions is identified, a signal is produced that is subsequently processed so that action is taken to prevent the loss or corruption of data and/or damage to the data storage device.

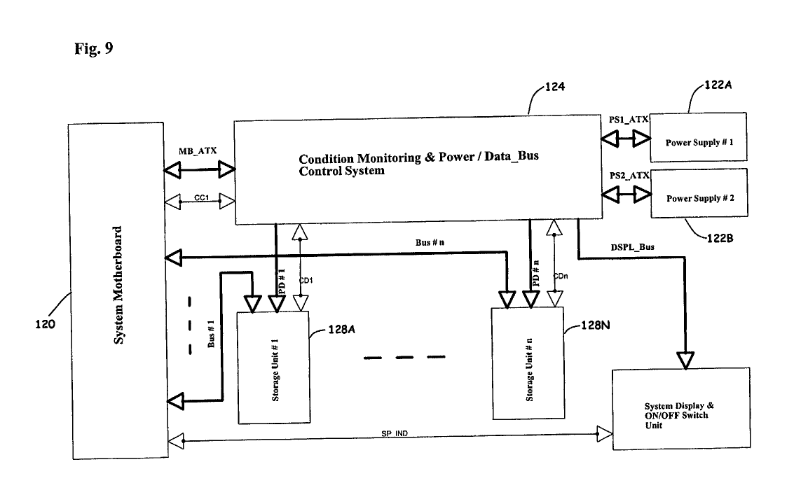

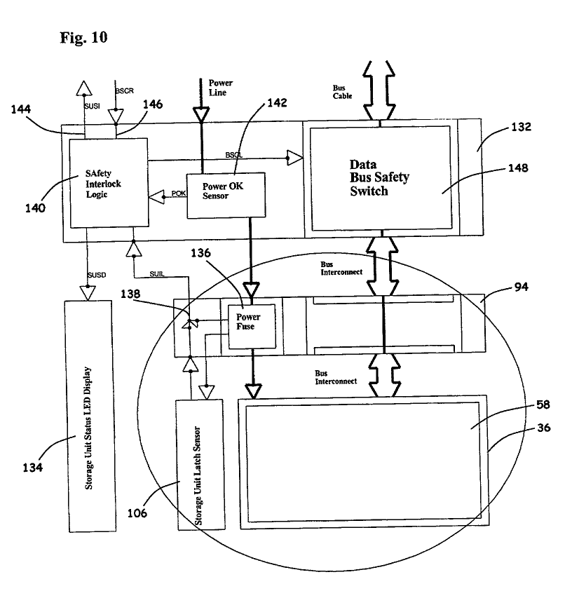

It should be appreciated that other types of sensors can be employed. For example, a mechanical sensor that includes an armature that contacts and senses the portion of the latch that moves through an “idle” distance can be employed. An example, of such a mechanical sensor is disclosed in U.S. patent application Ser. No. 09/681,458, which is incorporated herein by reference. Such a mechanical sensor is also adaptable to sensing relative movement between a carriage and another element within or part of the enclosure that is indicative of the possible removal of the carriage and any associated data storage device. Additionally, magnetic or electrical sensors can also be employed to sense the movement of an element of a latch or the relative movement between a carriage and another element that is within or part of the enclosure of the system 10. With reference to FIGS. 9-12, an embodiment of system for processing the signal produced by the sensor is described. Generally, the system processes the signal or signals output by the sensor such that if a data storage device is likely to be removed from the enclosure, the data bus over which data is transferred to and from the storage device is placed in a condition that prevents the loss or corruption of data and/or damage to the storage device. In the case of an IDE disk drive, the processing of a signal or signals indicative of likely removal of the drive involves actuating a switch that grounds each of the lines associated with the data bus.

The system for processing the signal or signals output by the sensor comprises a system motherboard 120. Associated with the motherboard 120 are a processor (not shown) for executing an operating system program that, among other things, processes the signal output by the sensor. The motherboard 120 also controls data transfers. More specifically, the motherboard 120 controls the transfer of data to and from each of the data storage devices in the enclosure 14 via data busses and the transfer of data to and from the exterior environment, i.e., the network infrastructure. The system further includes a pair of power supplies 122A, 122B, with one of the power supplies being the main power supply and the other power supply being a backup to the main power supply. Also include in the system is a Condition Monitoring and Power/Data Bus Control System board 124 that houses circuitry for monitoring various conditions within the enclosure 14 and communicating such information, as needed, to the operating system so that, if needed, appropriate action can be taken. Additionally, the board 124 provides circuitry for distributing power to any data storage devices within the enclosure 14 and the motherboard 120. With respect to the distribution of power to any data storage devices in the enclosure 14, the board 124 includes circuitry that distributes power according to directions issued by the operating system. Additionally, the board 124 includes circuitry that, in response to directions issued by the operating system, controls whether or not data is transferred to or from a data storage device.

The system for processing the sensor signal interfaces with one or more storage units 128A-128N that each include the carriage 36, a data storage device 58, a card 94, and a sensor 106. In addition, a storage unit includes a clamp card 132 and an LED display interface 134. The card 94, in addition to providing the power and data interfaces previously noted, includes a power fuse 136 and a signal pathway 138 for conveying the signal or signals produced by the sensor 106 to the clamp card 132. The signal pathway 138 also conveys a signal or signals relating to the condition of the power fuse 136. The clamp card 132, in addition to including the buss card terminal 92, includes safety interlock logic 138 for receiving information from the sensor 106 (via the signal pathway 138) and a power sensor 142 that monitors the power to a storage unit. The storage interlock logic 140 processes the information and, if appropriate, causes appropriate information to be conveyed onto the board 124 for further processing via an output link 144. The safety interlock logic 140 also receives information from the board 124 via input link 146. Also controlled by the safety interlock logic 140 is the data buss safety switch 148 that is used to place the data buss that communicates with the data storage device 58 in a secure condition when an operator endeavors to remove the carriage 36 and device 58 from the enclosure 14. The safety interlock logic 140 further controls the operation of the LED display interface 134.

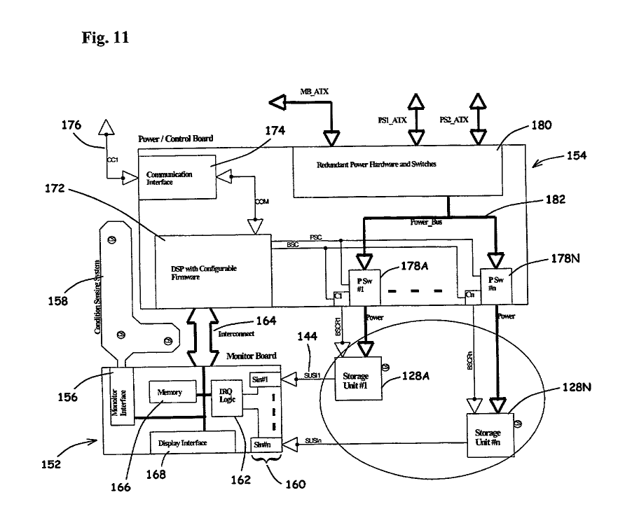

With reference to FIG. 11, the Condition Monitoring and Power/Data Buss Control System board 124 is described in greater detail. The board 124 is comprised of a monitor board 152 and a power/control board 154. The monitor board 152 operates to: (a) receive information from various sensors within the enclosure (e.g., temperature, vibration etc.), information conveyed over the output link 144 associated with each of the storage units 128A-128N; and information from the power/control board 154; (b) process the information; and (c) if appropriate, provide information to the power/control board 154 for further processing. The monitor board 152 includes a monitor interface 156 for receiving information from a collection of sensors associated with the system 10, including sensors associated with each storage device within the enclosure. Typical sensors include temperature and vibration sensors. A storage unit interface 160 is provided for receiving the signals conveyed over the output link 144 associated with each of the storage units 128A-128N. Real time interrupt logic 162 processes the information received at the monitor interface 156 and storage unit interface 160, as well as information received from the power/control board 154 via a communication link 164. In processing the information, the real-time interrupt logic 162 utilizes a memory 166 to store information. In many instances, the processing of the information received by the monitor board 152 results in information being conveyed to the power/control board via the communication link 164. In addition, in processing information, the real-time interrupt logic may update a display interface 168 that is used to provide a user with information on the condition of the system 10.

The power/control board 154 includes a digital signal processor 172, hereinafter referred to as the DSP 172, that communicates with the monitor board 152 through the communication link 164. The DSP 172 also communicates with the motherboard 120 and, more specifically, communicates by way of a communication interface 174 and motherboard communication link 176. The DSP 172 further operates to control the distribution of power to the storage units 128A-128N by way of power switches 178A-178N. Additionally, the DSP 172 provide signals to bus switch control connectors 178A-178N that are, in turn, conveyed to the safety interlock logic 140 for application to the data bus safety switch 148. The power/control board 154 also includes a power switch module 180 that is used to manage the power supplies 122A, 122B and, more specifically, switch between the main power supply and the backup power supply as needed. The module 180 also provides power to the motherboard 120 and a power buss 182 that interfaces to the power switches 178A-178N.

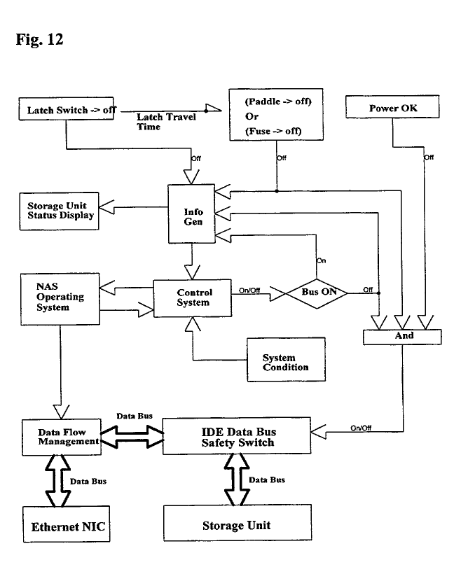

With reference to FIG. 12, the operation of the system for processing the signal or signals output by the sensor 106 when that carriage 36 and an associated data storage device 58 are removed from the enclosure 14 and power is being applied to the data storage device 58 is described. Generally, the latch mechanism and sensor 106 operate such that the sensor 106 generates a signal or signals indicative of the likely removal of the device 58 before the buss card terminal 92 and card terminal 100 are at a point at which any data being transferred over the data buss could be lost or corrupted or the storage device 58 damaged by an uncontrolled removal. The information embodied or represented by the signal or signals generated by the sensor 106 is conveyed to the operating system. In response, the operating system causes the data buss to be placed in a secure condition such that the continued removal of the carriage 36 and data storage device 58 substantially avoids the loss or corruption of data or damage to the device 58. In the case of the storage device 58 being an IDE or ATA disk drive, the operating system causes the data buss to be grounded.

With reference to FIGS. 3, 6 and 9-12, the operation is described in greater detail. Before the carriage 36 and an associated data storage device 58 are removed from the enclosure, the carriage 36 is positioned in one of the mounting bays 32A-32D such the flag 108 is disposed in front of both the first optical detector 112A and second optical detector 112B. Removal of the carriage 36 and an associated data storage device 58 when power is being applied to the device 58 is initiated by an operator beginning to pull the handle 68 away from the enclosure 14. As the handle 68 is pulled away, the position of the flag 108 changes such that it is no longer positioned in front of the second detector 112B. This causes a transition in the state of the signal being produced by the second detector 112B. As the handle is pulled further, the position of the flag 108 changes such that it is no longer positioned in front of the first optical detector 112A. This causes the signal output by the first optical detector 112A to change state. The change in the states of the signals output by the first and second optical detectors 112A and 112B indicates that the carriage 36 and the associated data storage device 58 are likely to be removed from the enclosure. The signals are conveyed, via the signal pathway 138, to the safety interlock logic 140. In turn, the safety interlock logic 140 communicates the likely removal of the storage device 58 to the monitor board 152 via the output line 144 and the storage unit interface 160. The real-time interrupt logic 162 responds by causing the information of the likely removal to be conveyed to the DSP 172 via the communication link 164. The DSP 172, in turn, causes the information to be conveyed to the motherboard 120 by way of the communication interface 174 and motherboard communication link 176.

The operating system on the motherboard 120 responds to the information that the data storage device 158 is likely to be removed by issuing a command to place the data buss that is used to transfer data to and from the device 158 in a secure condition to prevent the loss or corruption of any data being transferred and/or damage to the device 58. The command is conveyed to the DSP 172 by the motherboard communication link 176 and communication interface 174. In response, the DSP 172 causes signals to be issued to the safety interlock logic 146 via the appropriate buss switch control connector 178A-178N. The safety interlock logic 140 responds to the signal by causing the data buss safety switch 148 to be switched so that the data buss is placed in a secure condition that substantially prevents the loss or corruption of data and/or damage to the device 58. In the case of IDE/ATA drives, the data buss safety switch 148 causes the lines of the data buss to be grounded. Notably, the data buss is placed in a secure condition before the buss card terminal 92 and the card terminal 100 are at a point at which the noted problems would arise.

The safety interlock logic 140 implements a three input “AND” function in which one of the inputs is or relates to the presence or absence of the command from the operating system to secure the data buss. When the command is present, the output of the “AND” function causes the data buss to be secured. The output of the “AND” function also causes the data buss to be secured when either of the other two inputs indicate that a condition exists under which it would be desirable or prudent to secure the data buss. The first of the other two inputs is based on the information provided to the safety interlock logic 142 by the power sensor 142. If the power sensor 142 indicates that power is not being provided to the card 94, the “AND” logic of the safety interlock logic 142 causes the data buss to be secured. The second of the other two inputs is based on the information provided by the power fuse 136. If the power fuse 136 has been blown, the “AND” logic implemented by the safety interlock logic 142 causes the buss to be secured.

It should also be noted that whenever the data buss is secured, the operating system also communicates with data flow management software/hardware to halt any data being transferred to or from the exterior environment by, for example, a network interface card, in a controlled manner.

It should also be appreciated that modification of the system 10 so that the signal or signals produced by a sensor that senses movement indicative of the possible removal of a data storage device from the enclosure are processed other than by an operating system is feasible. For instance, processing hardware/software located between the operating system and the data storage device can be utilized to process the signal or signals produced by the sensor. One such location for such hardware/software would be on the clamp card 132. The hardware/software would respond to the signal or signals of the sensor by actuating the data bus safety switch 148. One advantage of hardware/software is that it would likely be capable of responding to the signal or signals more quickly than the operating system.

The embodiment described hereinabove is intended to explain the best mode known of practicing the invention and to enable others skilled in the art to utilize the invention.

1. A network attached storage system that provides the ability to hot swap a data storage device comprising:
an enclosure capable of holding at least one data storage device;
an interface for connecting the system to: (a) a network infrastructure that facilities communications between the system and another computer related device; and (b) a supply of power;
a first electrical interface, located within said enclosure, for providing power and data to a data storage device;
a mounting bay for a data storage device, said mounting bay comprises: (a) a carriage capable of holding a data storage device and comprising a second electrical interface that is capable of engaging said first electrical interface;
(b) a receiving structure capable of holding said carriage; and (c) a latch that allows said carriage to be operatively attached to said enclosure and detached from said enclosure;
a detector capable of: (a) sensing movement of a physical structure that is indicative of the possible disengagement of said second electrical interface of said carriage from said first electrical interface and (b) producing a signal indicative thereof; and
processing electronics for receiving said signal output by said detector and, after receiving said signal, causing action to be taken before said second electrical interface is disengaged from said first electrical interface to prevent the loss or corruption of any data being transferred to or from any data storage device associated with said carriage.

2. A network attached storage system, as claimed in claim 1, wherein:
said enclosure is capable of holding at least one block data storage device.

3. A network attached storage system, as claimed in claim 1, wherein:
said enclosure is capable of holding at least one disk drive.

4. A network attached storage system, as claimed in claim 1, wherein:
said enclosure is capable of holding an IDE disk drive.

5. A network attached storage system, as claimed in claim 1, wherein:
said carriage comprises an exterior covering for a data storage device.

6. A network attached storage system, as claimed in claim 1, wherein:
said receiving structure comprises a rail; and
said carriage comprises a slot for slidably engaging said rail.

7. A network attached storage system, as claimed in claim 6, wherein:
when said carriage is engaged to said rail and said carriage is holding a data storage device, both said carriage and said rail are substantially located between the data storage device and one of a top side and a bottom side of said enclosure.

8. A network attached storage system, as claimed in claim 1, wherein:
said latch comprises a latch actuator and a latch pin;
said latch actuator is operatively attached to one of said carriage and said enclosure; and
said latch pin is operatively attached to the other one of said carriage and said enclosure.

9. A network attached storage system, as claimed in claim 8, wherein:
said detector comprises a mechanical switch that mechanically senses movement of said latch actuator;
wherein said signal output by said mechanical switch has a first level when said latch actuator is located at a first position and a second level when said latch actuator moves to a second location that is indicative of the possible disengagement.

10. A network attached storage system, as claimed in claim 8, wherein:
said detector comprises an electro-optical switch that optically senses movement of said latch actuator;
wherein said signal output by said electro-optical switch has a first level when said latch actuator is located at a first position and a second level when said latch actuator moves to a second location that is indicative of the possible disengagement.

11. A network attached storage system, as claimed in claim 8, wherein:
said detector comprises a mechanical switch that mechanically senses relative movement between said carriage and said enclosure;
wherein said signal output by said mechanical switch has a first level when said latch actuator is located at a first position and a second level when said latch actuator moves to a second location that is indicative of the possible disengagement.

12. A network attached storage system, as claimed in claim 8, wherein:
said detector comprises an electro-optical switch that optically senses relative movement between said carriage and said enclosure;
wherein said signal output by said electro-optical switch has a first level when said latch actuator is located at a first position and a second level when said latch actuator moves to a second location that is indicative of the possible disengagement.

13. A network attached storage system, as claimed in claim 1, wherein:
said processing electronics comprises a switch for grounding all data lines associated with said first electrical interface.

14. A network attached storage system, as claimed in claim 1, wherein:
said processing electronics comprises an operating system.

15. A network attached storage system, as claimed in claim 1, wherein:
said processing electronics is located between an operating system and said first electrical interface.

16. A network attached storage system that provides the ability to hot swap a data storage device comprising:
an enclosure capable of holding at least one data storage device;
an interface for connecting the system to: (a) a network infrastructure that facilities communications between the system and another computer related device; and (b) a supply of power;
a first electrical interface, located within said enclosure, for providing power and data to a data storage device;
a mounting bay for a data storage device, said mounting bay comprises: (a) a carriage capable of holding a data storage device and comprises a second electrical interface that is capable of engaging said first electrical interface and a third electrical interface that is capable of engaging a fourth electrical interface associated with a data storage device; (b) a receiving structure capable of holding said carriage; and (c) a latch that allows said carriage to be operatively attached to said enclosure and detached from said enclosure;
a detector capable of: (a) sensing movement of a physical structure that is indicative of the possible disengagement of said second electrical interface of said carriage from said first electrical interface and (b) producing a signal indicative thereof;
a pathway for conveying said signal, said pathway being separate from said first electrical interface; and
processing electronics for receiving said signal output by said detector and, after receiving said signal, causing action to be taken before said second electrical interface is disengaged from said first electrical interface to prevent the loss or corruption of any data being transferred to or from any data storage device associated with said carriage.

17. A network attached storage system, as claimed in claim 16, wherein:
said carriage includes a card for holding said second electrical interface and said third electrical interface.

18. A method for providing the ability to “hot swap” a data storage device in a network attached storage device in a manner that substantially reduces the possibility of the loss or corruption of data being transferred between the data storage device and the exterior environment comprising:
sensing movement of a physical structure that is indicative of the possible separation of a first electrical interface from a second electrical interface that each provide electrical paths for data signals and power to a data storage device;
wherein said second electrical interface is located between said first electrical interface and a network interface of the network attached storage device;
producing an electrical signal indicative of sensed movement; and
responding to said electrical signal by taking action before such possible separation so as to prevent the loss or corruption of data being transferred to/from the data storage device.

19. A method, as claimed in claim 18, wherein:
said step of sensing comprises using an optical sensor.

20. A method, as claimed in claim 18, wherein:
said step of sensing comprises using a mechanical sensor.

21. A method, as claimed in claim 1, wherein:
said step of responding includes grounding all data lines associated with said second electrical interface.
